(19) United States
(12) Patent Application Publication
(10) Pub. No.: US 2004/0098716 A1
(43) Pub. Date: May 20, 2004

(54) Detecting system and method

(76) Inventor: Lin Cheng-Chung, Taipei Hsien (TW)

Correspondence Address: SHAW PITTMAN, IP GROUP, 1650 TYSONS BOULEVARD, SUITE 1300, MCLEAN, VA, 22102, US

(21) Appl. No.: 10/298,819

(22) Filed: Nov. 19, 2002

(51) Int. Cl. G06F 9/445

(52) U.S. Cl. 717/178

(57) ABSTRACT

A detecting system and method is applied in an intellectual information device comprising a read only memory and a flash access memory. The intellectual information device is connected to a server and is used for downloading development programs from sever into the flash access memory, executing the development programs and performing detection. The process of detecting a newly developed product comprises the steps. The development programs are downloaded from server and stored in flash access memory. If a user chooses to execute the development programs in flash access memory to enable the intellectual information device perform a booting-up operation, the intellectual information device will execute the development programs in flash access memory rather than the original software programs in read only memory. If the flash access memory does not comprise the development programs, the intellectual information device will execute the original software programs in read only memory.

### BACKGROUND OF THE INVENTION

1. Field of the Invention

The present invention relates to a technology for detecting programs of a newly developed product. Particularly, the present invention relates to a detecting system and method for downloading development programs from a server into a flash access memory of an intellectual information device and executing the development programs to perform detection.

2. Description of the Prior Art

As electronic technology advances, research and develop personnel have to improve functionality of a product and continuously develop and update versions of programs in electronic products. Generally, a prior art method for detecting the programs in the process of developing an electronic product is to burn development programs into a read only memory and then to detect whether the status of executing the development programs is correct by means of the read only memory emulator.

However, the drawbacks of the prior art method for detecting the development programs is that multiple product developers cannot jointly develop the product programs at the same time when the number of the provided ROM emulators is not enough. Besides, if the ROM emulators are not compatible with the development systems used by the product developers, the schedule of development of the product will be delayed and the time required for the development of the product will be increased.

Furthermore, the storage capacity of the ROM generally does not exceed 1 Mbyte, and 128 Kbyte is most often provided. If the size of the program developed by the developer exceeds the storage capacity of the ROM, the development program cannot be burned into the ROM so that some portions of the program have to be deleted to decrease the storage capacity occupied by the program. Consequently, the functionality of the electronic product will be decreased.

### SUMMARY OF THE INVENTION

Therefore, the primary object of the present invention is to provide a detecting system and method wherein the several developers can simultaneously detect the programs of the newly developed products, without using multiple ROM emulators, so as to decrease the time required for the development of the products.

Another object of the present invention is to provide a detecting system and method wherein the programs developed in different systems can be detected, without using multiple different types of the ROM emulators, so as to decrease the cost of the development of the programs.

Another object of the present invention is to provide a detecting system and method wherein the product developers can load the development programs into the storage devices of the products regardless of the storage capacities of the ROMs.

Another object of the present invention is to provide a detecting system and method wherein the recently versions of the development programs of the products can be detected easily and quickly, without dismounting the housings of the products to replace or re-burn the ROM, so as to update the versions of the programs of the products.

According to the mentioned objects, the present invention provides a detecting system and method. The detecting system of the present invention comprises an intellectual information device, a server, and a transmission interface for connecting the intellectual information device and the server. The intellectual information device comprises a central processing unit for executing system programs and functional programs of the intellectual information device and performing logical operations and coordination controls; a read only memory coupled to the central processing unit comprising system programs and some functional programs set when shipping out the intellectual information device; a flash access memory coupled to the central processing unit for storing the programs and data downloaded from the server; and a random access memory having an expanding access memory area coupled to the central processing unit for storing the working parameters when the central processing unit is operating and being a temporary working area when the programs is downloaded from the server. When the flash access memory of the intellectual information device does not comprise the development programs downloaded from the server, the intellectual information device will execute the system programs and the functional programs originally set when shipping out, stored in the read only memory and have the functionality originally set when shipping out.

By using the detecting system and method of the present invention, in the process of developing the programs, first of all, the server will download the development programs and store them in the flash access memory. If a detector chooses to execute the development programs in the flash access memory to boot up the intellectual information device, the intellectual information device will execute the development programs in the flash access memory rather than the original software programs in the read only memory. If the flash access memory does not have the downloaded development programs, the intellectual information device will execute the original software programs in the read only memory. The intellectual information device can be any information appliance, such as a mobile phone, a personal digital assistant (PDA), and so on, and the server can be any development device used for designing programs and processing data, such as a notebook computer, a desktop computer, and so on. The transmission interface can be any connecting unit for connecting the intellectual information device to the server, such as a parallel port transmission line, a local area network, and so on.

By connecting the intellectual information device to the server via the transmission interface, the intellectual information device can download the different versions of the development programs from the server into the flash access memory so as to provide a detecting method for a product developer to perform the detection of the programs more easily and quickly.

These and other objectives of the present invention will no doubt become obvious to those of ordinary skill in the art after having read the following detailed description of the preferred embodiment, which is illustrated in the various figures and drawings.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective diagram of a detecting system according to the present invention;

FIG. 2 is a flowchart of downloading the programs and data from the server by using the detecting system according to the present invention;

FIG. 3 is a perspective diagram of allocation of storing addresses of the detecting system according to the present invention;

FIG. 4 shows the content stored in a recording area 324 of the flash access memory; and

FIG. 5 is a flowchart of performing detection by using a detecting method in accordance with an embodiment of the present invention.

### DETAILED DESCRIPTION OF THE PREFERRED EMBODIMENT

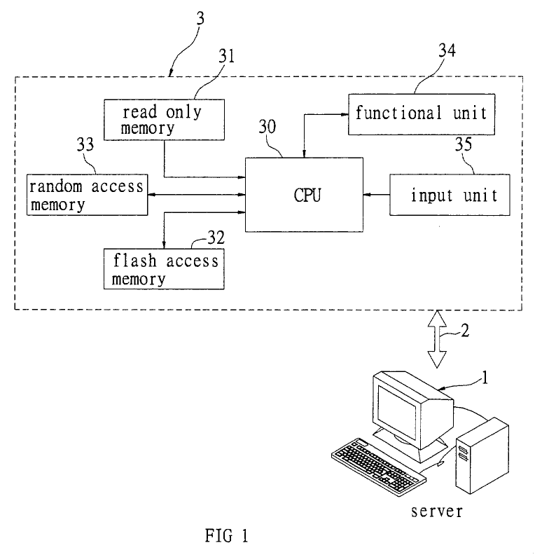

Please refer to FIG. 1. FIG. 1 is a perspective diagram of a detecting system according to the present invention. The detecting system comprises an intellectual information device 3, a server 1, and a transmission interface 2 for connecting the intellectual information device 3 to the server 1. The intellectual information device 3 can be any information appliance, such as a mobile phone, a personal digital assistant (PDA), and so on, and the server 1 can be any computer host used for designing programs and processing data, such as a notebook computer, a desktop computer, and so on. The transmission interface 2 can be any connecting unit for connecting the intellectual information device 3 and the server 1, such as a parallel port transmission line, a local area network, and so on.

The intellectual information device 3 comprises a central processing unit 30, a read only memory 31, a flash access memory 32, a random access memory 33, a functional unit 34, and an input unit 35.

The central processing unit 30 is connected to the other components, and is used for executing the system programs and functional programs in the intellectual information device 3, and performing logical operations and coordination controls. If the development programs downloaded from the server 3 are not stored in the flash access memory 32, the central processing unit 30 will execute the system programs and the functional programs originally set when shipping out the intellectual information device 3, stored in the read only memory 31. If the downloaded development programs are stored in the flash access memory 32, the central processing unit 30 will execute the development programs in the flash access memory 32 rather than the original software programs in the read only memory 31. However, when the intellectual information device 3 executes the downloading operation, the central processing unit 30 will execute downloading programs having downloading functionality in read only memory 31 so that the intellectual information device 3 will download data and programs from the server 1.

The read only memory 31 is coupled to the central processing unit 30 for storing the system programs and functional programs originally set when shipping out the intellectual information device 3. The programs in the read only memory 31 only can be read out, and no programs can be written into the read only memory 31. The programs stored in the read only memory 31 will not be eliminated even when the power supply is interrupted.

The flash access memory 32 is coupled to the central processing unit 30, and is used for storing the programs and data downloaded from the server 1. Multiple writing operations can be executed to the flash access memory 32; therefore, the development program, programs with different functionalities and data provided in the server 1 can be downloaded into the intellectual information device 3 in several times for detecting the functionality of the developed product.

The random access memory 33 is coupled to the central processing unit 30, and comprises an expanding access memory area. The random access memory 33 is used for storing the working parameters when the central processing unit 30 is operating, and for being a temporary working area when downloading programs and data from the server 1. Repeated reading and writing operations can be executed to the random access memory 33; however, the programs and data in the random access memory 33 will be eliminated when the power supply is interrupted.

The functional unit 34 is coupled to the central processing unit 30, and the functional unit 34 has the functionality provided by the intellectual information device 1. For example, if the intellectual information device 1 is a mobile phone, the functional unit 34 will have the functions of dialing, hanging on/up, communicating, and ringing.

The input unit 35 is coupled to the central processing unit 30, and is used for providing an option for the detector to switch the intellectual information device 3 to a booting-up mode so as to choose the intellectual information device 3 to execute the system programs stored in the read only memory 31 or execute the downloaded development programs stored in the flash access memory 32 for booting up. The input unit 35 may comprises a keyboard or a mouse. A hotkey is mounted on the keyboard, and is used for providing the detector an option to execute the programs in the read only memory 31 or to execute the development programs in the flash access memory 32 for booting up.

Furthermore, the intellectual information device 3 has a data reception unit (not shown). After the server 1 transmits the data to the data reception unit via the transmission interface 2, the intellectual information device 3 will be able to download the data in the server 1.

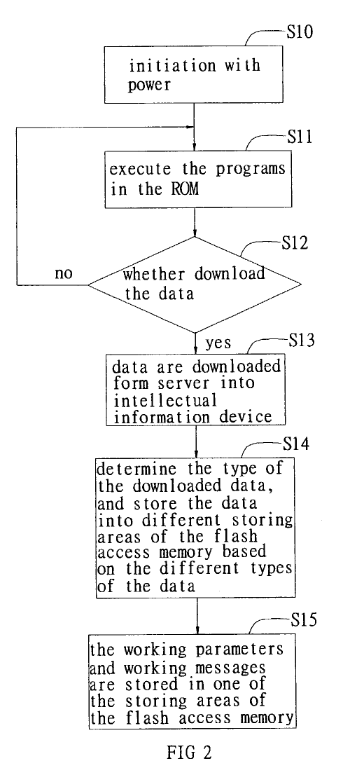

Please refer to FIG. 2. FIG. 2 is a flowchart of downloading the programs and data from the server 1 by using the detecting system according to the present invention. First, in step S10, the intellectual information device 3 is powered to initiate, and then go to the step S11.

In the step S11, the intellectual information device 3 executes the system programs and functional programs in the read only memory 31 which are previously set when shipping out the intellectual information device 3, and go to the step S12.

In the step S12, it is determined whether the user downloads the data or programs in the server 1. If yes, then go the step S13; otherwise, go to the step S11.

In the step 13, the data or programs are downloaded form the server 1 into the intellectual information device 3, and then go to the step S14.

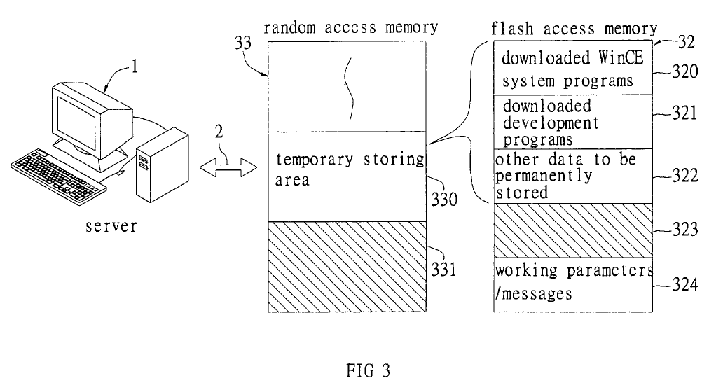

In the step S14, the type of the downloaded data is determined, and the data is written into different storing areas of the flash access memory 32 based on the different types of the data. Then, go the step S15. The storing areas will be depicted in FIG. 3.

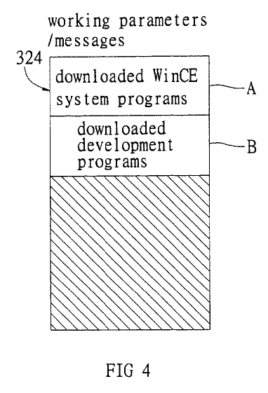

In the step S15, the working parameters and working messages generated during downloading are stored in one of the storing areas of the flash access memory 32. The working parameters and working messages will be depicted in FIG. 4.

After the user presses down the power button (not shown) of the intellectual information device 3, the intellectual information device 3 will first read the system programs or the functional programs in the read only memory 31 so as to enable the functional unit 34 operates correspondingly based on the functional programs. The functional programs comprise the programs for executing the operation of downloading data. Therefore, when the user connects the intellectual information device 3 and the server 1 by means of the transmission interface 2, and inputs a downloading request by using the input unit 35. For example, the user presses down a specific key on the keyboard (not shown) for executing the operation of downloading data. Thus, the data in the server 1 is downloaded into the intellectual information device 3 via the transmission interface 2.

Please refer to FIG. 3. FIG. 3 is a perspective diagram of allocation of storing addresses of the detecting system according to the present invention. As shown in FIG. 3, the corresponding relationships of addresses between the random access memory 33 and the flash access memory 32 are depicted. The storing area 330 of the random access memory 33 is used as a temporary working area when the user downloads the development programs from the server 1 to the intellectual information device 3, and the central processing unit 30 will temporarily store the development programs in the storing area 330. The storing area 331 is an expanding access memory area of the random access memory 33 and is used for temporarily storing other data. Herein, there is no data stored.

When the downloaded development programs are stored in the random access memory 33, at the same time, the central processing unit 30 will execute the programs in the read only memory 31 so as to store the downloaded data with different types in the different storing areas of the flash access memory 32 separately. Therefore, even when the intellectual information device 3 is not supplied with power, the downloaded data are permanently stored in the flash access memory 32, and will not be eliminated. If the type of the downloaded data is a WinCE system program for executing the operations in a PDA, the data will be stored in the storing area 320. If the type of the downloaded data is a development program, the data will be stored in the storing area 321. If the data has to be permanently preserved, such as a form, the data will be stored in the storing area 32. Besides, the storing area 323 filled with oblique lines is an area where no data is stored and is used for storing other downloaded data.

When the different types of data are separately stored in the storing areas 320, 321, 322 of the flash access memory 32, a recording area 324 is appointed to record the working parameters and the working messages. The content stored in the recording area 324 is used for recording the types of the downloaded data and marking the storing addresses of the downloaded data in the flash access memory 32. Therefore, the central processing unit 30 can obtain the development programs from the flash access memory 32 and then perform the detection of the downloaded development programs.

Please refer to FIG. 4. FIG. 4 shows the content stored in a recording area 324 of the flash access memory 32. When the downloaded data is written into the flash access memory 32, the working parameters and working messages generated during the writing operation will be stored in the recording area 324. As a result, the recording area 324 is divided into several storing blocks according to the different data types. For example, a storing block A shows the WinCE system programs have been downloaded from the server 1 into the flash access memory 32, and the storing addresses of the WinCE system programs in the flash access memory 32 are stored in the storing block A. The storing block B shows the development programs have been downloaded from the server 1 into the flash access memory 32, and the storing addresses of the development programs in the flash access memory 32 are stored in the storing block B.

Therefore, when the user detects the development programs, the central processing unit 30 will first determine whether the recording area 324 of the flash access memory 32 have the storing block B showing the presence of the development programs. If the determination is positive, the development programs will be read by using the addresses stored in the storing block B.

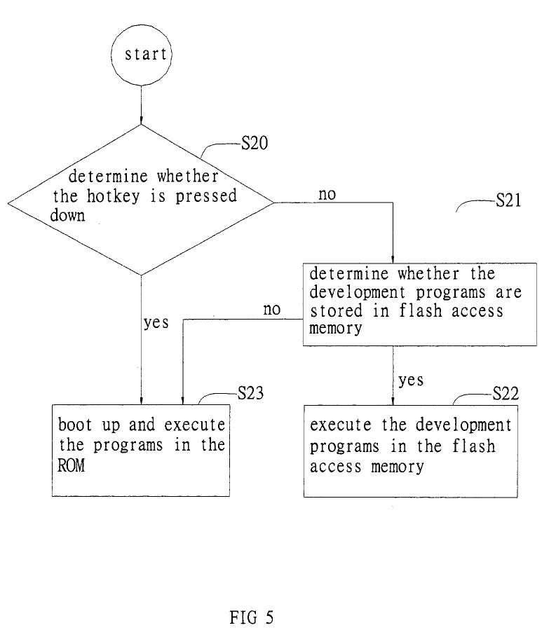

Please refer to FIG. 5. FIG. 5 is a flowchart of performing detection by using a detecting method in accordance with an embodiment of the present invention. First, the step S20 is performed to determine whether the user presses down the hotkey of the keyboard. If yes, then go to the step S23; otherwise, go to the step S21.

In the step S21, determine whether the development programs are stored in the flash access memory 32. If yes, then go to the step S22; otherwise, go to the step S23. In this step, the central processing unit 30 will search for the storing block B in the recording area 324 of the flash access memory 32. If the storing block B is found out, the central processing unit 30 will read the content of the storing block B, and obtain the addresses of the development programs in the flash access memory 32.

In the step S22, the central processing unit 30 will operates based on the development programs in the flash access memory 32, and therefore, the detector can directly detect the development programs in the intellectual information device 3. Besides, the functionalities of functional units 34 in the intellectual information device 3 can be updated so as to provide the user more functions.

In the step S23, boot up and execute the programs in the read only memory 31. Namely, the central processing unit 30 operates based on the system programs and functional programs stored in the read only memory 31.

In the present invention, the product developers can execute the development programs in the product so as to detect the operating status among the development programs and the product and load programs with new versions into the product so as to detect the newly added functions of the product without dismounting the housing of the product for replacing or re-burning the read only memory. The developers only have to connect the server (such as a personal computer or a notebook) having the development programs to the product to be detected by means of a transmission interface (such as a parallel port transmission line) so that the development programs can be directly stored in the flash access memory of the product. Therefore, by using the detecting system and method according to the present invention, the detection of a product being able to be detected only after the assembly of the product is finished can be performed without damaging the machine assembly. The present invention also can provide a simple detecting method to the systems (namely, information appliances, such as mobile phones, PDAs) internally embedded with storage devices and having no externally-connected storage devices, such as floppy disk drives or memory cards. Since multiple reading and writing operations can be executed to the flash access memory, the detection of the development programs can be performed without replacing or re-burning the read only memory so as to greatly decrease the cost of the development of the product, even when the number of the read only memory emulators is not enough.

Furthermore, because of the flash access memory, the development programs in the server can be downloaded in several times so as to detect the different versions of the development programs. The development programs or data meeting different needs in the server can be downloaded in several times so as to increase the number of functions in the product. Besides, because the development programs are stored in the flash access memory according to the present invention, the storage space occupied by the development programs will not limited by the capacity of the read only memory, and the a number of powerful functions can be increased, such as a function of storing the records generated when detecting, a function of storing debugging messages for warning the detector when errors happen in detection.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A detecting system for downloading development programs and data from a server into an intellectual information device via a transmission interface, the intellectual information device executing operations based on the development programs and data and detecting the development programs, comprising:
a central processing unit for executing system programs and functional programs of the intellectual information device or enabling the intellectual information device executing the development programs downloaded from the server;
a read only memory coupled to the central processing unit for storing the system programs and the functional programs originally set by the intellectual information device;
a flash access memory coupled to the central processing unit for storing the development programs and data downloaded from the server, and separately storing the data in different storing areas according to different types of the data, and generating storing blocks corresponding to each of the storing areas, the storing blocks being for recording the addresses of the corresponding storing areas stored in the flash access memory and for recoding working parameters of data types of the corresponding storing areas so that the central processing unit accessing the flash access memory for reading and executing according to the development programs appointed by a detector;
a random access memory having an expanding access memory area coupled to the central processing unit for storing the working parameters when the central processing unit being operating, and for being a temporary working area when downloading the development programs and data from the server;
a functional unit coupled to the central processing unit, having functions originally provided by the intellectual information device; and
an input unit coupled to the central processing unit for providing an option for the detector to choose a booting-up mode in the intellectual information device to choose the intellectual information device executing the system programs and functional programs stored in the read only memory or executing the downloaded development programs stored in the flash access memory so as to boot up.

2. The detecting system of claim 1, wherein the input unit is a keyboard, the keyboard has a hot-key device for providing an option to enable the intellectual information device executing the system programs stored in the read only memory so as to boot up.

3. The detecting system of claim 1, wherein the server is a desktop computer.

4. The detecting system of claim 1, wherein the server is notebook computer.

5. The detecting system of claim 1, wherein the transmission interface is a parallel port transmission line.

6. The detecting system of claim 1, wherein the transmission interface is a local area network.

7. The detecting system of claim 1, wherein the different types of data comprise WinCE system programs, development programs and other data to be permanently stored.

8. The detecting system of claim 1, wherein the intellectual information device is a mobile phone.

9. The detecting system of claim 1, wherein the intellectual information device is a PDA.

10. A detecting method applied in an intellectual information device comprising a read only memory and a flash access memory, the intellectual information device being connected to the server by means of a transmission interface for downloading development programs from the sever, executing the development programs and performing detection, the method comprising:
determining whether a user inputting a command to enable the read only memory to execute a booting-up operation, if the user inputting the command, the system programs stored in the read only memory will being executed so as to boot up; and
if the user not inputting the command, determining whether the development programs downloaded from the server being stored in the flash access memory, if the development programs being stored, the development programs stored in the flash access memory will being executed; otherwise, the system programs stored in the read only memory will being executed to boot up.

11. The detecting method of claim 10, wherein the process of the intellectual information device downloading the programs and data from the server comprising:
after powering on the intellectual information device, the intellectual information device executing the system programs and functional programs stored in the read only memory;
determining whether a user downloading the data or programs from the server;
if the user not executing the download operation, going to the previous step, if the user executing the download operation, the data or programs will being downloaded from the server to the intellectual information device; and
determining the type of the downloaded data, and writing the data into different storing areas of the flash access memory according to the different types of the data, simultaneously recording storing addresses and data parameters of the downloaded data in a recording area.

12. The detecting method of claim 10, wherein inputting of the command to execute the booting-up operation by means of the read only memory is executed by an input unit.

13. The detecting method of claim 10, wherein the input unit is a keyboard, the keyboard has a hotkey for inputting the command to execute the booting-up operation by means of the read only memory.

14. The detecting method of claim 10, wherein the server is a desktop computer.

15. The detecting method of claim 10, wherein the server is notebook computer.

16. The detecting method of claim 10, wherein the transmission interface is a parallel port transmission line.

17. The detecting method of claim 10, wherein the transmission interface is a local area network.

18. The detecting method of claim 11, wherein the different types of data comprise WinCE system programs, development programs and other data to be permanently stored.

19. The detecting method of claim 11, wherein the recording area is divided into multiple storing blocks according to the different types of the data so as to separately store working parameters and working messages generated when downloading the different types of the data.

20. The detecting method of claim 10, wherein the intellectual information device is a mobile phone.

21. The detecting method of claim 10, wherein the intellectual information device is a PDA.
